(19) United States
(12) Patent Application Publication
(10) Pub. No.: US 2026/0161139 A1
(43) Pub. Date: Jun. 11, 2026

(54) SYSTEMS AND METHODS FOR FACILITATING MANAGEMENT OF A FACILITY OPERATION ASSOCIATED WITH A FACILITY USING DIGITAL TWINS

(71) Applicant: Luke Macy, Laramie, WY (US)

(72) Inventor: Luke Macy, Laramie, WY (US)

(21) Appl. No.: 19/179,822

(22) Filed: Apr. 15, 2025

Related U.S. Application Data
(60) Provisional application No. 63/637,222, filed on Apr. 22, 2024.

(51) Int. Cl. G05B 13/02; H04L 9/40

(52) U.S. Cl. CPC G05B 13/0265; H04L 63/0428

(57) ABSTRACT

The present disclosure provides a method for facilitating management of a facility operation associated with a facility using digital twins. Further, the method may include receiving a contextual-factor data device. Further, the facility device may be comprised in the facility. Further, the contextual-factor data represents one or more of an environment in relation and a user behavior in relation. Further, the method may include analyzing the contextual-factor data. Further, the method may include identifying a user preference data based on the analyzing. Further, the user preference data corresponds of the user in relation. Further, the method may include generating a facility operation data based on the user preference data. Further, the facility operation data corresponds to operation. Further, the facility operation may be in relation. Further, the method may include transmitting the facility operation data.

The current application claims a priority to the U.S. provisional patent application Ser. No. 63/637,222 filed on Apr. 22, 2024.

### FIELD OF THE INVENTION

The present invention relates generally to data processing. More specifically, the present invention is systems and methods for facilitating management of a facility operation associated with a facility using digital twins.

### BACKGROUND OF THE INVENTION

The field of data processing is technologically important to several industries, business organizations, and/or individuals.

Existing building management systems are limited by a focus on facility efficiency over occupant experience. Current technologies for digital twin applications in facility management are predominantly asset-centric, not occupant-centric, overlooking the variable and influential presence of occupants. Further, current technologies do not align the potential of digital twins with the dynamic needs of occupants for improved environmental interaction, sustainability, and well-being.

Therefore, there is a need for improved systems and methods for facilitating management of a facility operation associated with a facility using digital twins that may overcome one or more of the above-mentioned problems and/or limitations.

### SUMMARY OF THE INVENTION

This summary is provided to introduce a selection of concepts in a simplified form that are further described below in the Detailed Description. This summary is not intended to identify key features or essential features of the claimed subject matter. Nor is this summary intended to be used to limit the claimed subject matter's scope.

The present disclosure provides a method for facilitating management of a facility operation associated with a facility using digital twins. Further, the method may include receiving, using a communication device, a contextual-factor data from a facility device. Further, the facility device may be comprised in the facility. Further, the contextual-factor data represents one or more of an environment in relation to the facility and a user behavior associated with a user in relation to the facility. Further, the method may include analyzing, using a processing device, the contextual-factor data. Further, the method may include identifying, using the processing device, a user preference data based on the analyzing. Further, the user preference data corresponds to a preference of the user in relation to the facility. Further, the method may include generating, using the processing device, a facility operation data based on the user preference data. Further, the facility operation data corresponds to the facility operation. Further, the facility operation may be in relation to the facility device. Further, the method may include transmitting, using the communication device, the facility operation data to the facility device.

The present disclosure provides a system for facilitating management of a facility operation associated with a facility using digital twins. Further, the system may include a communication device. Further, the communication device may be configured for receiving a contextual-factor data from a facility device. Further, the facility device may be comprised in the facility. Further, the contextual-factor data represents one or more of an environment in relation to the facility and a user behavior associated with a user in relation to the facility. Further, the communication device may be configured for transmitting a facility operation data to the facility device. Further, the system may include a processing device. Further, the processing device may be configured for analyzing the contextual-factor data. Further, the processing device may be configured for identifying a user preference data based on the analyzing. Further, the user preference data corresponds to a preference of the user in relation to the facility. Further, the processing device may be configured for generating a facility operation data based on the user preference data. Further, the facility operation data corresponds to the facility operation. Further, the facility operation may be in relation to the facility device.

Both the foregoing summary and the following detailed description provide examples and are explanatory only. Accordingly, the foregoing summary and the following detailed description should not be considered to be restrictive. Further, features or variations may be provided in addition to those set forth herein. For example, embodiments may be directed to various feature combinations and sub-combinations described in the detailed description.

### BRIEF DESCRIPTION OF THE DRAWINGS

The accompanying drawings, which are incorporated in and constitute a part of this disclosure, illustrate various embodiments of the present disclosure. The drawings contain representations of various trademarks and copyrights owned by the Applicants. In addition, the drawings may contain other marks owned by third parties and are being used for illustrative purposes only. All rights to various trademarks and copyrights represented herein, except those belonging to their respective owners, are vested in and the property of the applicants. The applicants retain and reserve all rights in their trademarks and copyrights included herein, and grant permission to reproduce the material only in connection with reproduction of the granted patent and for no other purpose.

Furthermore, the drawings may contain text or captions that may explain certain embodiments of the present disclosure. This text is included for illustrative, non-limiting, explanatory purposes of certain embodiments detailed in the present disclosure.

FIG. 1 is an illustration of an online platform 100 consistent with various embodiments of the present disclosure.

FIG. 2 is a block diagram of a computing device 200 for implementing the methods disclosed herein, in accordance with some embodiments.

FIG. 3 illustrates a flowchart of a method 300 for facilitating management of a facility operation associated with a facility using digital twins, in accordance with some embodiments.

FIG. 4 illustrates a flowchart of a method 400 for facilitating management of a facility operation associated with a facility using digital twins including generating, using the processing device 704, a user alert data, in accordance with some embodiments.

FIG. 5 illustrates a flowchart of a method 500 for facilitating management of a facility operation associated with a facility using digital twins including determining, using the processing device 704, the AI module configured for generating the facility operation, in accordance with some embodiments.

FIG. 6 illustrates a flowchart of a method 600 for facilitating management of a facility operation associated with a facility using digital twins including generating, using the processing device 704, each of an anonymized contextual-factor data, an anonymized facility operation data, an anonymized user feedback data and an anonymized user alert data, in accordance with some embodiments.

FIG. 7 illustrates a block diagram of a system 700 for facilitating management of a facility operation associated with a facility using digital twins, in accordance with some embodiments.

FIG. 8 illustrates a flowchart of a method 800 for facilitating management of a facility operation associated with a facility using digital twins including generating, using the processing device 704, an efficiency enhancement suggestion data corresponding to a suggestion for enhancing an efficiency associated with the facility, in accordance with some embodiments.

FIG. 9 is a schematic of a system for facilitating management of a facility operation associated with a facility using digital twins, in accordance with some embodiments.

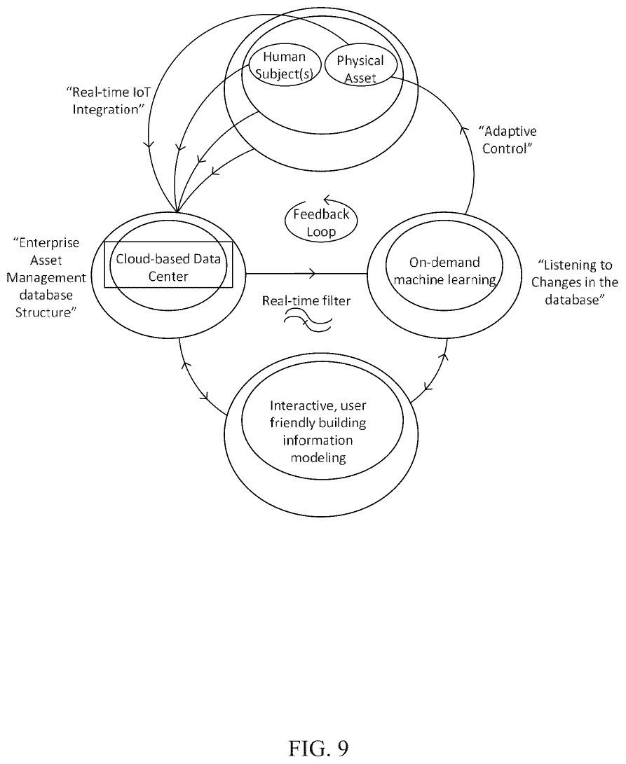

FIG. 10 illustrates a method for facilitating management of a facility operation associated with a facility using digital twins, in accordance with some embodiments.

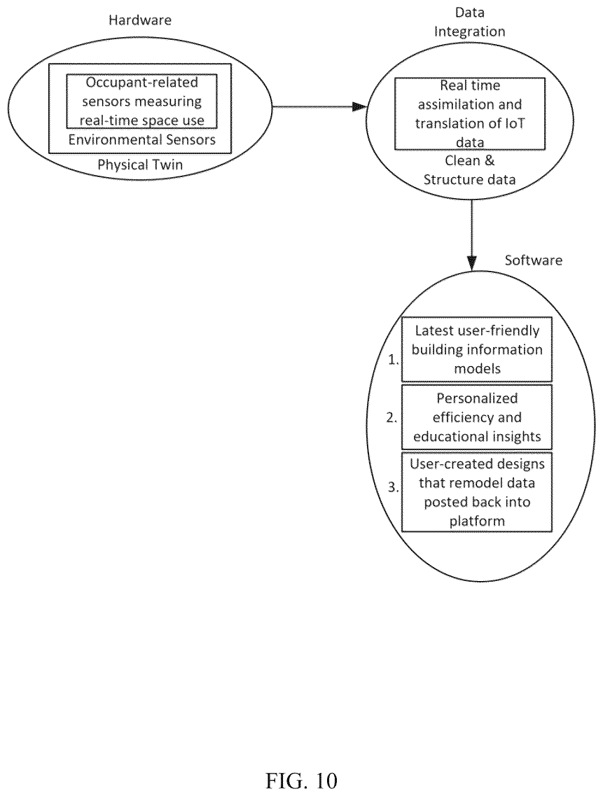

### DETAILED DESCRIPTION OF THE INVENTION

As a preliminary matter, it will readily be understood by one having ordinary skill in the relevant art that the present disclosure has broad utility and application. As should be understood, any embodiment may incorporate only one or a plurality of the above-disclosed aspects of the disclosure and may further incorporate only one or a plurality of the above-disclosed features. Furthermore, any embodiment discussed and identified as being “preferred” is considered to be part of a best mode contemplated for carrying out the embodiments of the present disclosure. Other embodiments also may be discussed for additional illustrative purposes in providing a full and enabling disclosure. Moreover, many embodiments, such as adaptations, variations, modifications, and equivalent arrangements, will be implicitly disclosed by the embodiments described herein and fall within the scope of the present disclosure.

Accordingly, while embodiments are described herein in detail in relation to one or more embodiments, it is to be understood that this disclosure is illustrative and exemplary of the present disclosure and are made merely for the purposes of providing a full and enabling disclosure. The detailed disclosure herein of one or more embodiments is not intended, nor is to be construed, to limit the scope of patent protection afforded in any claim of a patent issuing here from, which scope is to be defined by the claims and the equivalents thereof. It is not intended that the scope of patent protection be defined by reading into any claim limitation found herein and/or issuing here from that does not explicitly appear in the claim itself.

Thus, for example, any sequence(s) and/or temporal order of steps of various processes or methods that are described herein are illustrative and not restrictive. Accordingly, it should be understood that, although steps of various processes or methods may be shown and described as being in a sequence or temporal order, the steps of any such processes or methods are not limited to being carried out in any particular sequence or order, absent an indication otherwise. Indeed, the steps in such processes or methods generally may be carried out in various different sequences and orders while still falling within the scope of the present disclosure. Accordingly, it is intended that the scope of patent protection is to be defined by the issued claim(s) rather than the description set forth herein.

Additionally, it is important to note that each term used herein refers to that which an ordinary artisan would understand such term to mean based on the contextual use of such term herein. To the extent that the meaning of a term used herein—as understood by the ordinary artisan based on the contextual use of such term—differs in any way from any particular dictionary definition of such term, it is intended that the meaning of the term as understood by the ordinary artisan should prevail.

Furthermore, it is important to note that, as used herein, “a” and “an” each generally denote “at least one” but does not exclude a plurality unless the contextual use dictates otherwise. When used herein to join a list of items, “or” denotes “at least one of the items” but does not exclude a plurality of items of the list. Finally, when used herein to join a list of items, “and” denotes “all of the items of the list”.

The following detailed description refers to the accompanying drawings. Wherever possible, the same reference numbers are used in the drawings and the following description to refer to the same or similar elements. While many embodiments of the disclosure may be described, modifications, adaptations, and other implementations are possible. For example, substitutions, additions, or modifications may be made to the elements illustrated in the drawings, and the methods described herein may be modified by substituting, reordering, or adding stages to the disclosed methods. Accordingly, the following detailed description does not limit the disclosure. Instead, the proper scope of the disclosure is defined by the claims found herein and/or issuing here from. The present disclosure contains headers. It should be understood that these headers are used as references and are not to be construed as limiting upon the subjected matter disclosed under the header.

The present disclosure includes many aspects and features. Moreover, while many aspects and features relate to, and are described in the context of the disclosed use cases, embodiments of the present disclosure are not limited to use only in this context.

In general, the method disclosed herein may be performed by one or more computing devices. For example, in some embodiments, the method may be performed by a server computer in communication with one or more client devices over a communication network such as, for example, the Internet. In some other embodiments, the method may be performed by one or more of at least one server computer, at least one client device, at least one network device, at least one sensor and at least one actuator. Examples of the one or more client devices and/or the server computer may include, a desktop computer, a laptop computer, a tablet computer, a personal digital assistant, a portable electronic device, a wearable computer, a smart phone, an Internet of Things (IoT) device, a smart electrical appliance, a video game console, a rack server, a super-computer, a mainframe computer, mini-computer, micro-computer, a storage server, an application server (e.g., a mail server, a web server, a real-time communication server, an FTP server, a virtual server, a proxy server, a DNS server, etc.), a quantum computer, and so on. Further, one or more client devices and/or the server computer may be configured for executing a software application such as, for example, but not limited to, an operating system (e.g., Windows, Mac OS, Unix, Linux, Android, etc.) in order to provide a user interface (e.g., GUI, touch-screen based interface, voice based interface, gesture based interface, etc.) for use by the one or more users and/or a network interface for communicating with other devices over a communication network. Accordingly, the server computer may include a processing device configured for performing data processing tasks such as, for example, but not limited to, analyzing, identifying, determining, generating, transforming, calculating, computing, compressing, decompressing, encrypting, decrypting, scrambling, splitting, merging, interpolating, extrapolating, redacting, anonymizing, encoding and decoding. Further, the server computer may include a communication device configured for communicating with one or more external devices. The one or more external devices may include, for example, but are not limited to, a client device, a third-party database, public database, a private database and so on. Further, the communication device may be configured for communicating with the one or more external devices over one or more communication channels. Further, the one or more communication channels may include a wireless communication channel and/or a wired communication channel. Accordingly, the communication device may be configured for performing one or more of transmitting and receiving of information in electronic form. Further, the server computer may include a storage device configured for performing data storage and/or data retrieval operations. In general, the storage device may be configured for providing reliable storage of digital information. Accordingly, in some embodiments, the storage device may be based on technologies such as, but not limited to, data compression, data backup, data redundancy, deduplication, error correction, data finger-printing, role-based access control, and so on.

Further, one or more steps of the method disclosed herein may be initiated, maintained, controlled and/or terminated based on a control input received from one or more devices operated by one or more users such as, for example, but not limited to, an end user, an admin, a service provider, a service consumer, an agent, a broker and a representative thereof. Further, the user as defined herein may refer to a human, an animal or an artificially intelligent being in any state of existence, unless stated otherwise, elsewhere in the present disclosure. Further, in some embodiments, the one or more users may be required to successfully perform authentication in order for the control input to be effective. In general, a user of the one or more users may perform authentication based on the possession of a secret human readable secret data (e.g., username, password, passphrase, PIN, secret question, secret answer, etc.) and/or possession of a machine readable secret data (e.g., encryption key, decryption key, bar codes, etc.) and/or or possession of one or more embodied characteristics unique to the user (e.g., biometric variables such as, but not limited to, fingerprint, palm-print, voice characteristics, behavioral characteristics, facial features, iris pattern, heart rate variability, evoked potentials, brain waves, and so on) and/or possession of a unique device (e.g., a device with a unique physical and/or chemical and/or biological characteristic, a hardware device with a unique serial number, a network device with a unique IP/MAC address, a telephone with a unique phone number, a smartcard with an authentication token stored thereupon, etc.). Accordingly, the one or more steps of the method may include communicating (e.g., transmitting and/or receiving) with one or more sensor devices and/or one or more actuators in order to perform authentication. For example, the one or more steps may include receiving, using the communication device, the secret human readable data from an input device such as, for example, a keyboard, a keypad, a touch-screen, a microphone, a camera and so on. Likewise, the one or more steps may include receiving, using the communication device, the one or more embodied characteristics from one or more biometric sensors.

Further, one or more steps of the method may be automatically initiated, maintained and/or terminated based on one or more predefined conditions. In an instance, the one or more predefined conditions may be based on one or more contextual variables. In general, the one or more contextual variables may represent a condition relevant to the performance of the one or more steps of the method. The one or more contextual variables may include, for example, but are not limited to, location, time, identity of a user associated with a device (e.g., the server computer, a client device, etc.) corresponding to the performance of the one or more steps, environmental variables (e.g., temperature, humidity, pressure, wind speed, lighting, sound, etc.) associated with a device corresponding to the performance of the one or more steps, physical state and/or physiological state and/or psychological state of the user, physical state (e.g., motion, direction of motion, orientation, speed, velocity, acceleration, trajectory, etc.) of the device corresponding to the performance of the one or more steps and/or semantic content of data associated with the one or more users. Accordingly, the one or more steps may include communicating with one or more sensors and/or one or more actuators associated with the one or more contextual variables. For example, the one or more sensors may include, but are not limited to, a timing device (e.g., a real-time clock), a location sensor (e.g., a GPS receiver, a GLONASS receiver, an indoor location sensor, etc.), a biometric sensor (e.g., a fingerprint sensor), an environmental variable sensor (e.g., temperature sensor, humidity sensor, pressure sensor, etc.) and a device state sensor (e.g., a power sensor, a voltage/current sensor, a switch-state sensor, a usage sensor, etc. associated with the device corresponding to performance of the or more steps).

Further, the one or more steps of the method may be performed one or more number of times. Additionally, the one or more steps may be performed in any order other than as exemplarily disclosed herein, unless explicitly stated otherwise, elsewhere in the present disclosure. Further, two or more steps of the one or more steps may, in some embodiments, be simultaneously performed, at least in part. Further, in some embodiments, there may be one or more time gaps between performance of any two steps of the one or more steps.

Further, in some embodiments, the one or more predefined conditions may be specified by the one or more users. Accordingly, the one or more steps may include receiving, using the communication device, the one or more predefined conditions from one or more and devices operated by the one or more users. Further, the one or more predefined conditions may be stored in the storage device. Alternatively, and/or additionally, in some embodiments, the one or more predefined conditions may be automatically determined, using the processing device, based on historical data corresponding to performance of the one or more steps. For example, the historical data may be collected, using the storage device, from a plurality of instances of performance of the method. Such historical data may include performance actions (e.g., initiating, maintaining, interrupting, terminating, etc.) of the one or more steps and/or the one or more contextual variables associated therewith. Further, machine learning may be performed on the historical data in order to determine the one or more predefined conditions. For instance, machine learning on the historical data may determine a correlation between one or more contextual variables and performance of the one or more steps of the method. Accordingly, the one or more predefined conditions may be generated, using the processing device, based on the correlation.

Further, one or more steps of the method may be performed at one or more spatial locations. For instance, the method may be performed by a plurality of devices interconnected through a communication network. Accordingly, in an example, one or more steps of the method may be performed by a server computer. Similarly, one or more steps of the method may be performed by a client computer. Likewise, one or more steps of the method may be performed by an intermediate entity such as, for example, a proxy server. For instance, one or more steps of the method may be performed in a distributed fashion across the plurality of devices in order to meet one or more objectives. For example, one objective may be to provide load balancing between two or more devices. Another objective may be to restrict a location of one or more of an input data, an output data and any intermediate data therebetween corresponding to one or more steps of the method. For example, in a client-server environment, sensitive data corresponding to a user may not be allowed to be transmitted to the server computer. Accordingly, one or more steps of the method operating on the sensitive data and/or a derivative thereof may be performed at the client device.

### Overview

The present disclosure describes methods and systems for facilitating providing occupant-centric Digital Twins as a Service (DTaaS). Further, the disclosed system may be configured for providing an Occupant-Centric Digital Twins as a Service (DTaaS). Further, the disclosed system may provide a cloud-based platform that integrates artificial intelligence, IoT, and advanced data analytics to enhance the experiences of occupants in various built environments. The system dynamically adjusts operations to optimize comfort, efficiency, and sustainability in real-time, while fostering occupant engagement and well-being through a centralized platform.

Further, the disclosed system may be configured for utilizing digital twin technology as a scalable service for real-time enhancement of occupant experiences and operational efficiency in diverse built environments through cloud-based systems.

Further, the disclosed system provides a DTaaS platform that synthesizes real-time data from IoT devices within any facility, using cloud computing to create a digital twin that models not just the physical attributes but also the behavioral patterns and preferences of occupants. Further, the disclosed system may use artificial intelligence to process this data to predict needs and adapt the facility operations to improve occupant understanding of facilities, comfort, efficiency, and sustainability.

Further, the disclosed system may be configured for performing occupant behavior modeling. Further, the disclosed system may use AI and machine learning algorithms to analyze data from IoT devices, applications, and occupant feedback, creating nuanced behavior and preference profiles. Further, the disclosed system may be configured for performing real-time environmental adjustments. The system autonomously adjusts conditions such as lighting and climate in response to occupant behavior analysis, promoting comfort and efficiency.

Further, occupant behavior data informs the optimization of resource consumption, encouraging sustainable practices and providing actionable insights for occupants to minimize their ecological impact. Further, the disclosed system may be configured for providing personalized notifications and suggestions. Further, the disclosed system may be configured for providing customized information to occupants regarding facility use, health, history, safety, and additional metadata based on digital twin analysis. Further, the disclosed system may seamlessly interact with pre-existing management systems and third-party applications, broadening functionality and improving the user experience. Advanced security protocols are established to safeguard occupant data and adhere to privacy standards (e.g., limiting the view for occupants to access assets downstream in the asset tree). Further, the disclosed system may encourage occupant feedback, participation in sustainability programs, and community involvement are included, enhancing engagement in the management and betterment of the facility.

Further, the disclosed system may be configured for collecting and analyzing data from internet-of-things (IoT) and industrial IoT (IIoT) sources and adapting facility operations to enhance the occupant experience and operational efficiency. Further, the disclosed system may be configured for ensuring interoperability with existing management systems and third-party applications to offer an all-encompassing facility management solution. Further, the disclosed system may provide a cloud infrastructure for data handling, IoT devices for sensory data acquisition, and interfaces for interactive occupant communication.

Further, the disclosed system may be based on a revolutionary DTaaS approach, placing occupants at the core of the digital twin framework for facilities. Further, the disclosed system may be configured for transforming the management and perception of spaces to foster environments that are more sustainable, efficient, and pleasurable for occupants.

Further, the disclosed system may be configured for the enhancement of occupant experiences and operational efficiency within various facilities. By using the Occupant-Centric Digital Twin as a Service (DTaaS), the system creates a dynamic model of the facility that interacts in real-time with data regarding environmental conditions and occupant behaviors, aiming to improve comfort, sustainability literacy, and efficiency.

The disclosed system operates by integrating Internet of Things (IoT) and Industrial Internet of Things (IIoT) data with cloud computing and Artificial Intelligence (AI) analytics. Further, the disclosed system may be configured to collect data in real-time, process and analyze it to understand and predict occupant needs and then use this information to adjust the facilities' operations. This real-time adaptation ensures enhanced occupant understanding of their facilities, occupant comfort while housed in facilities, and improved operational efficiency.

Further, the disclosed system may include a sensing hardware that consists of IoT and IoT sensors that collect data on environmental conditions and occupant behaviors. Further, the disclosed system may process IoT data to clean anrange ande it, using techniques such as trimming outliers through an interquartile range, and featuring algorithms like the Ensemble Kalman Filter (EnKF) for predictive analytics and imputation techniques to fill data gaps.

Further, the disclosed system may be associated with a software application/software. Further, the software may provide Building Information Modeling (BIM) interfaces and AI-powered tools that provide efficiency insights and educational information, as well as adapt building operations based on the analyzed data.

Further, the disclosed system may include a Cloud-based Data Center that manages, processes and stores the data, maintaining data security and privacy in compliance with regulations.

Further, the disclosed method may include data collection from the IoT and IoT sensors. Further, the disclosed method may include data assimilation and translation into a structured format within the cloud-based data center. Further, the method may include the application of AI and machine learning algorithms for data analysis and behavior prediction. Further, the method may include real-time adjustment of the facility's operations for enhanced occupant comfort. Further, the disclosed method may include occupant engagement through user interfaces for feedback and communal decision-making (e.g., community-built dashboards, maintenance requests, AI-generated efficiency suggestions from large language models (LLMs)).

Further, components comprised in the system are systematically arranged to foster a responsive and intelligent system (drafted architecture drawings provide greater insight. Further, the disclosed system may include sensors (Hardware) strategically placed in the facility to monitor various aspects of the environment and the occupants. Further, the data from these sensors is fed into the Cloud-based Data Center, where it is processed and analyzed. Further, the software, using AI, takes this data to simulate and predict occupant needs, generating actionable insights and adaptations. Further, the system may include a Data Integration Hub that filters and refines the raw data, maintaining its relevance and usefulness for ongoing operations. Further, the disclosed system may be based on Communication Protocols that ensure real-time and secure data flow among system components, crucial for responsive adaptations. These protocols may be in the form of Web Sockets or RESTful HTTP requests.

Further, the disclosed system may provide feedback loops that leverage real-time data and user feedback to continuously improve the system's accuracy and efficiency.

The present disclosure describes systems and methods for an Occupant-Centric Digital Twins as a Service (DTaaS), which integrates edge and cloud computing with machine learning to dynamically optimize energy efficiency and enhance the productivity of people, including occupants in built environments to contribute to energy efficiency. The system may utilize a hierarchical machine learning framework that operates at various levels, enabling immediate sensor-driven responses and strategic long-term adaptations for building management.

Further, the disclosed system may be configured for integrating Edge and Cloud Computing, where edge nodes conduct real-time data processing to minimize latency, and cloud platforms execute deep learning and extensive predictive modeling. The Dynamic Data-Driven Adaptation Protocol (DDAP) allows the system to continuously learn and adjust operational strategies based on real-time data, environmental changes, and feedback from occupants.

Further, privacy is enhanced through Occupant-Centric Modeling, incorporating data anonymization and employing differential privacy within machine learning operations. The disclosed system also includes an Integrated Behavioral and Environmental Sensory Network that combines data from environmental conditions and indirect behavioral indicators, enabling predictive adjustments without compromising privacy.

The present disclosure is designed to improve the management of building systems by focusing on occupant comfort and sustainable energy use while maintaining operational efficiency and data privacy standards. Further, scalable architecture associated with the DTaaS system facilitates deployment across various facility types, enhancing its applicability in building management:

### 1. Hierarchical Machine Learning Framework:

Develop a multi-layered machine learning approach where different models operate at various levels of decision-making.
Detailed Mechanism:
   Level 1—Immediate Responses: Use lightweight models (e.g., Decision Trees, SVM) for quick adjustments based on real-time sensor data (e.g., occupancy sensors triggering adjustments in HVAC settings).
   Level 2—Short-term Predictions: Employ Recurrent Neural Networks (RNNs), particularly LSTM models, to forecast short-term occupant behavior and environmental changes over hours or days.
   Level 3—Long-term Strategy: Implement Reinforcement Learning (RL) algorithms to develop long-term strategies for energy management and occupant comfort that adapt over seasons and occupant feedback cycles.

### 2. Fusion of Edge and Cloud Computing:

Integrate edge computing devices capable of processing data locally with cloud-based analytics for heavy-duty processing, achieving a balance between immediacy and depth of data analysis.
Detailed Mechanism:
   Edge Nodes: Deploy edge computing nodes that pre-process data from IoT sensors for immediate actions, reducing latency and bandwidth use for high-frequency data.
   Cloud Analytics: Use cloud platforms for deep learning and complex predictive models that require significant computational power and historical data analysis.

### 3. Dynamic Data-Driven Adaptation Protocol (DDAP):

Develop a proprietary protocol for dynamic adaptation based on continuous learning and model updating.
Detailed Mechanism:
   Real-Time Learning: Implement online machine learning techniques that update models continuously as new data is collected, without the need for batch processing.
   Model Adaptation: Utilize adaptive algorithms that adjust their parameters in response to feedback from occupant behavior and external environmental changes.
      4. Occupant-Centric Modeling with Privacy Preservation:
Focus on occupant behavior modeling while employing techniques to anonymize and secure personal data, ensuring privacy.
Detailed Mechanism:
   Anonymization Layers: Integrate data anonymization techniques directly into IoT sensors and data collection protocols.
   Differential Privacy: Apply differential privacy in the machine learning models to ensure individual occupant data cannot be reverse-engineered from outputs.
   Occupant Feedback Interface: Develop secure interfaces through which occupants can provide feedback or preferences without revealing their identity. This may include anonymized interactive polls, comfort sliders, or preference toggles within an app, all designed to enhance occupant experience without tracing data back to individuals.
   Adaptive Feedback Algorithms: Utilize machine learning algorithms that adapt to aggregate feedback in real-time, adjusting models and systems without needing to attribute changes to specific individuals. These algorithms can learn general preferences and trends over time, improving the system's responsiveness and accuracy.
   End-to-End Encryption: Ensure that all data transmitted between IoT devices, data processors, and storage systems is encrypted using strong encryption protocols, making interception and unauthorized access difficult.
   Role-Based Access Controls (RBAC): Implement strict access controls based on the role within the DTaaS architecture, ensuring that only authorized personnel can access data for legitimate purposes, and even then, only in an anonymized or aggregated form.

### 5. Integrated Behavioral and Environmental Sensory Network:

Utilize a network of IoT and IIoT sensors that not only collect environmental data but also gather indirect behavioral indicators.
Detailed Mechanism:
   Sensor Fusion: Combine data from traditional environmental sensors with non-intrusive behavioral sensors (e.g., ultrasonic sensors to detect presence without identifying individuals).
   Predictive Feedback System: Implement a feedback mechanism where sensor data influences model predictions, which in turn adjust the sensor data collection strategy, optimizing both energy usage and data collection efficiency.

Further, in an instance, an occupant may feel that a room is too cold. The occupant may use a mobile app to adjust their preferred temperature range. The system receives this input through a secure, anonymized interface, processes the feedback in real-time using differentially private algorithms, and adjusts the HVAC settings accordingly without logging specific user details or preferences. The aggregated data from all occupants could later be analyzed to adjust the default settings of the HVAC system for efficiency and comfort, still preserving the anonymity of individual inputs.

Further, by enhancing the Occupant-Centric Modeling with these detailed mechanisms, the DTaaS system not only respects and protects occupant privacy but also dynamically adapts to real-time feedback to continuously improve living and working environments within buildings while optimizing energy efficiency.

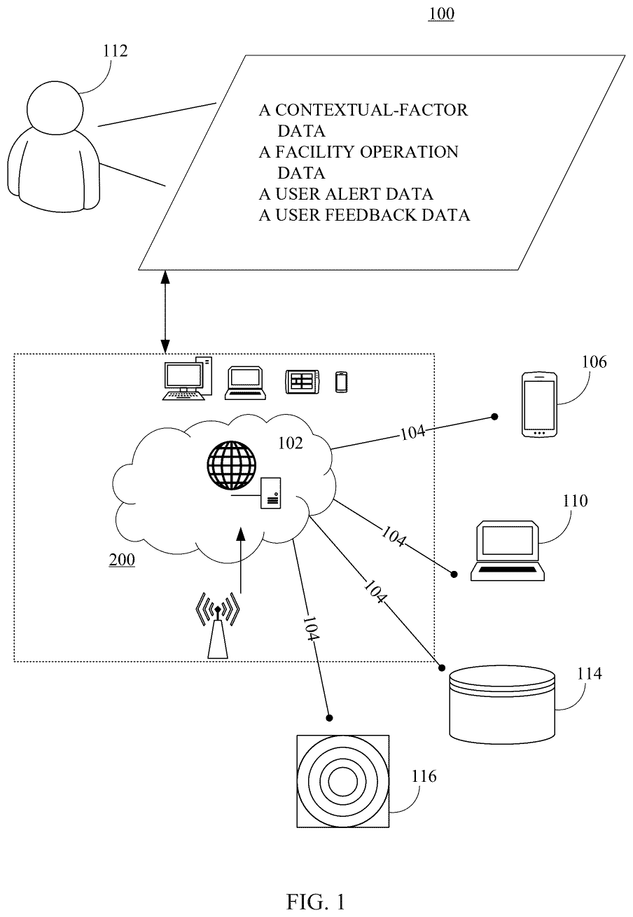

FIG. 1 is an illustration of an online platform 100 consistent with various embodiments of the present disclosure. By way of non-limiting example, the online platform 100 may be hosted on a centralized server 102, such as, for example, a cloud computing service. The centralized server 102 may communicate with other network entities, such as, for example, a mobile device 106 (such as a smartphone, a laptop, a tablet computer, etc.), other electronic devices 110 (such as desktop computers, server computers, etc.), databases 114, and sensors 116 over a communication network 104, such as, but not limited to, the Internet. Further, users of the online platform 100 may include relevant parties such as, but not limited to, end-users, administrators, service providers, service consumers and so on. Accordingly, in some instances, electronic devices operated by the one or more relevant parties may be in communication with the platform.

A user 112, such as the one or more relevant parties, may access online platform 100 through a web-based software application or browser. The web-based software application may be embodied as, for example, but not be limited to, a website, a web application, a desktop application, and a mobile application compatible with a computing device 200.

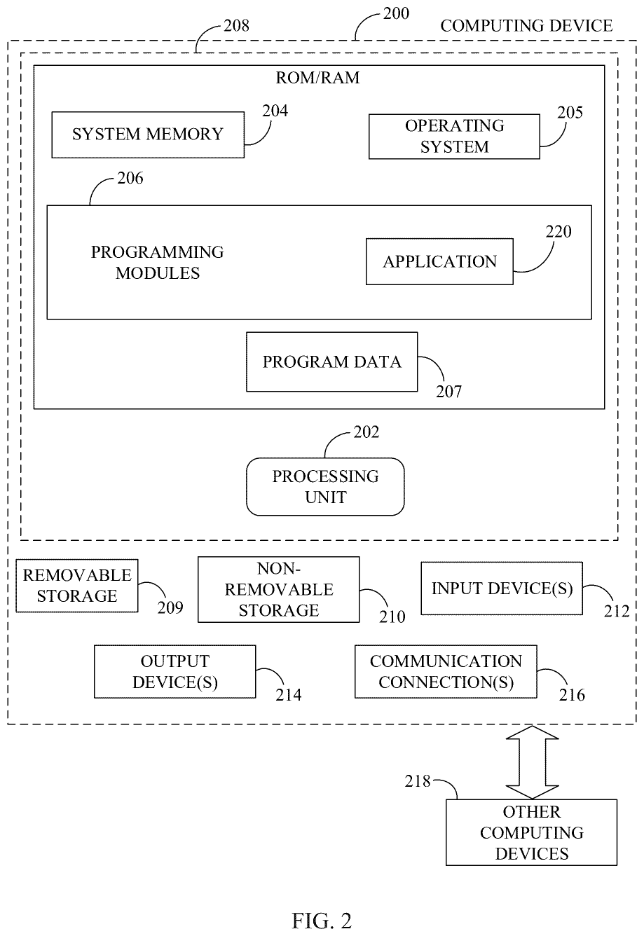

With reference to FIG. 2, a system consistent with an embodiment of the disclosure may include a computing device or cloud service, such as computing device 200. In a basic configuration, computing device 200 may include at least one processing unit 202 and a system memory 204. Depending on the configuration and type of computing device, system memory 204 may comprise, but is not limited to, volatile (e.g., random-access memory (RAM)), non-volatile (e.g., read-only memory (ROM)), flash memory, or any combination. System memory 204 may include operating system 205, one or more programming modules 206, and may include a program data 207. Operating system 205, for example, may be suitable for controlling computing device 200's operation. In one embodiment, programming modules 206 may include an image-processing module, a machine learning module, etc. Furthermore, embodiments of the disclosure may be practiced in conjunction with a graphics library, other operating systems, or any other application program and is not limited to any particular application or system. This basic configuration is illustrated in FIG. 2 by those components within a dashed line 208.

Computing device 200 may have additional features or functionality. For example, computing device 200 may also include additional data storage devices (removable and/or non-removable) such as, for example, magnetic disks, optical disks, or tape. Such additional storage is illustrated in FIG. 2 by a removable storage 209 and a non-removable storage 210. Computer storage media may include volatile and non-volatile, removable and non-removable media implemented in any method or technology for storage of information, such as computer-readable instructions, data structures, program modules, or other data. System memory 204, removable storage 209, and non-removable storage 210 are all computer storage media examples (i.e., memory storage.) Computer storage media may include, but is not limited to, RAM, ROM, electrically erasable read-only memory (EEPROM), flash memory or other memory technology, CD-ROM, digital versatile disks (DVD) or other optical storage, magnetic cassettes, magnetic tape, magnetic disk storage or other magnetic storage devices, or any other medium which can be used to store information and which can be accessed by computing device 200. Any such computer storage media may be part of device 200. Computing device 200 may also have input device(s) 212 such as a keyboard, a mouse, a pen, a sound input device, a touch input device, a location sensor, a camera, a biometric sensor, etc. Output device(s) 214 such as a display, speakers, a printer, etc. may also be included. The aforementioned devices are examples and others may be used.

Computing device 200 may also contain a communication connection 216 that may allow device 200 to communicate with other computing devices 218, such as over a network in a distributed computing environment, for example, an intranet or the Internet. Communication connection 216 is one example of communication media. Communication media may typically be embodied by computer readable instructions, data structures, program modules, or other data in a modulated data signal, such as a carrier wave or other transport mechanism, and includes any information delivery media. The term “modulated data signal” may describe a signal that has one or more characteristics set or changed in such a manner as to encode information in the signal. By way of example, and not limitation, communication media may include wired media such as a wired network or direct-wired connection, and wireless media such as acoustic, radio frequency (RF), infrared, and other wireless media. The term computer readable media as used herein may include both storage media and communication media.

As stated above, a number of program modules and data files may be stored in system memory 204, including operating system 205. While executing on processing unit 202, programming modules 206 (e.g., application 220 such as a media player) may perform processes including, for example, one or more stages of methods, algorithms, systems, applications, servers, databases as described above. The aforementioned process is an example, and processing unit 202 may perform other processes. Other programming modules that may be used in accordance with embodiments of the present disclosure may include machine learning applications.

Generally, consistent with embodiments of the disclosure, program modules may include routines, programs, components, data structures, and other types of structures that may perform particular tasks or that may implement particular abstract data types. Moreover, embodiments of the disclosure may be practiced with other computer system configurations, including hand-held devices, general purpose graphics processor-based systems, multiprocessor systems, microprocessor-based or programmable consumer electronics, application specific integrated circuit-based electronics, minicomputers, mainframe computers, and the like. Embodiments of the disclosure may also be practiced in distributed computing environments where tasks are performed by remote processing devices that are linked through a communications network. In a distributed computing environment, program modules may be located in both local and remote memory storage devices.

Furthermore, embodiments of the disclosure may be practiced in an electrical circuit comprising discrete electronic elements, packaged or integrated electronic chips containing logic gates, a circuit utilizing a microprocessor, or on a single chip containing electronic elements or microprocessors. Embodiments of the disclosure may also be practiced using other technologies capable of performing logical operations such as, for example, AND, OR, and NOT, including but not limited to mechanical, optical, fluidic, and quantum technologies. In addition, embodiments of the disclosure may be practiced within a general-purpose computer or in any other circuits or systems.

Embodiments of the disclosure, for example, may be implemented as a computer process (method), a computing system, or as an article of manufacture, such as a computer program product or computer readable media. The computer program product may be a computer storage media readable by a computer system and encoding a computer program of instructions for executing a computer process. The computer program product may also be a propagated signal on a carrier readable by a computing system and encoding a computer program of instructions for executing a computer process. Accordingly, the present disclosure may be embodied in hardware and/or in software (including firmware, resident software, micro-code, etc.). In other words, embodiments of the present disclosure may take the form of a computer program product on a computer-usable or computer-readable storage medium having computer-usable or computer-readable program code embodied in the medium for use by or in connection with an instruction execution system. A computer-usable or computer-readable medium may be any medium that can contain, store, communicate, propagate, or transport the program for use by or in connection with the instruction execution system, apparatus, or device.

The computer-usable or computer-readable medium may be, for example but not limited to, an electronic, magnetic, optical, electromagnetic, infrared, or semiconductor system, apparatus, device, or propagation medium. More specific computer-readable medium examples (a non-exhaustive list), the computer-readable medium may include the following: an electrical connection having one or more wires, a portable computer diskette, a random-access memory (RAM), a read-only memory (ROM), an erasable programmable read-only memory (EPROM or Flash memory), an optical fiber, and a portable compact disc read-only memory (CD-ROM). Note that the computer-usable or computer-readable medium could even be paper or another suitable medium upon which the program is printed, as the program can be electronically captured, via, for instance, optical scanning of the paper or other medium, then compiled, interpreted, or otherwise processed in a suitable manner, if necessary, and then stored in a computer memory.

Embodiments of the present disclosure, for example, are described above with reference to block diagrams and/or operational illustrations of methods, systems, and computer program products according to embodiments of the disclosure. The functions/acts noted in the blocks may occur out of the order as shown in any flowchart. For example, two blocks shown in succession may in fact be executed substantially concurrently or the blocks may sometimes be executed in the reverse order, depending upon the functionality/acts involved.

While certain embodiments of the disclosure have been described, other embodiments may exist. Furthermore, although embodiments of the present disclosure have been described as being associated with data stored in memory and other storage mediums, data can also be stored on or read from other types of computer-readable media, such as secondary storage devices, like hard disks, solid state storage (e.g., USB drive), or a CD-ROM, a carrier wave from the Internet, or other forms of RAM or ROM. Further, the disclosed methods' stages may be modified in any manner, including by reordering stages and/or inserting or deleting stages, without departing from the disclosure.

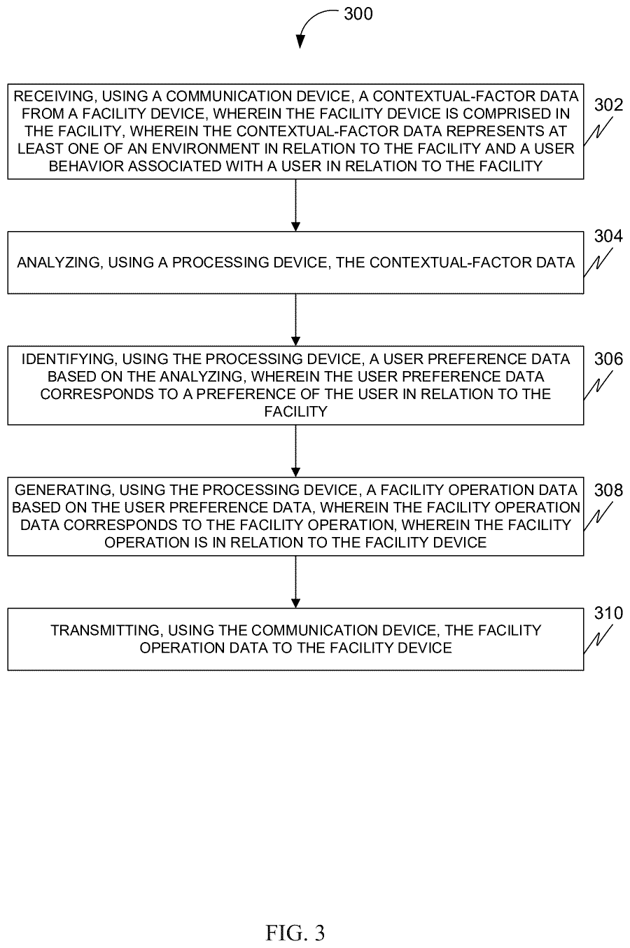

FIG. 3 illustrates a flowchart of a method 300 for facilitating management of a facility operation associated with a facility using digital twins, in accordance with some embodiments.

Accordingly, the method 300 may include a step 302 of receiving, using a communication device 702, a contextual-factor data from a facility device. Further, the facility device may be comprised in the facility. Further, the contextual-factor data represents one or more of an environment in relation to the facility and a user behavior associated with a user in relation to the facility. Further, the method 300 may include a step 304 of analyzing, using a processing device 704, the contextual-factor data. Further, the method 300 may include a step 306 of identifying, using the processing device 704, a user preference data based on the analyzing. Further, the user preference data corresponds to a preference of the user in relation to the facility. Further, the method 300 may include a step 308 of generating, using the processing device 704, a facility operation data based on the user preference data. Further, the facility operation data corresponds to the facility operation. Further, the facility operation may be in relation to the facility device. Further, the method 300 may include a step 310 of transmitting, using the communication device 702, the facility operation data to the facility device.

In some embodiments, the method 300 may further include generating, using the processing device 704, a facility-digital twin data corresponding to a digital twin of the facility. Further, the generating of the facility operation data may be further based on the facility-digital twin data.

In some embodiments, the analyzing of the contextual-factor data may be based on an AI module.

In some embodiments, the generating of the facility-digital twin may be based on a Digital Twins as a Service architecture which may be configured for facilitating one or more of a creation and a management of the digital twin of a physical asset. Further, the facility may be comprised in the physical asset.

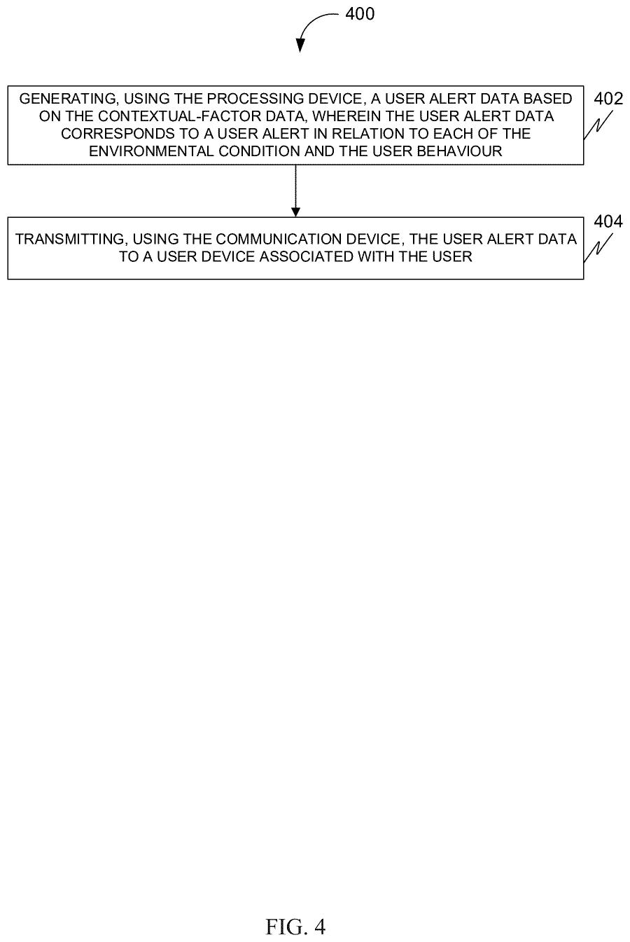

FIG. 4 illustrates a flowchart of a method 400 for facilitating management of a facility operation associated with a facility using digital twins including generating, using the processing device 704, a user alert data, in accordance with some embodiments.

Further, in some embodiments, the method 400 further may include a step 402 of generating, using the processing device 704, a user alert data based on the contextual-factor data. Further, the user alert data corresponds to a user alert in relation to each of the environmental condition and the user behavior. Further, in some embodiments, the method 400 further may include a step 404 of transmitting, using the communication device 702, the user alert data to a user device associated with the user.

In some embodiments, the user alert data may be configured to be presented on a user presentation device associated with the user device. Further, the user device includes a user input device which may be configured for receiving a user feedback data corresponding to a feedback in relation to the user alert. Further, the user device further includes a user communication device which may be configured for transmitting the user feedback data to the communication device 702 further comprising receiving, using the communication device 702, the user feedback data from the user device. Further, the generating of the facility operation data may be further based on the user feedback data.

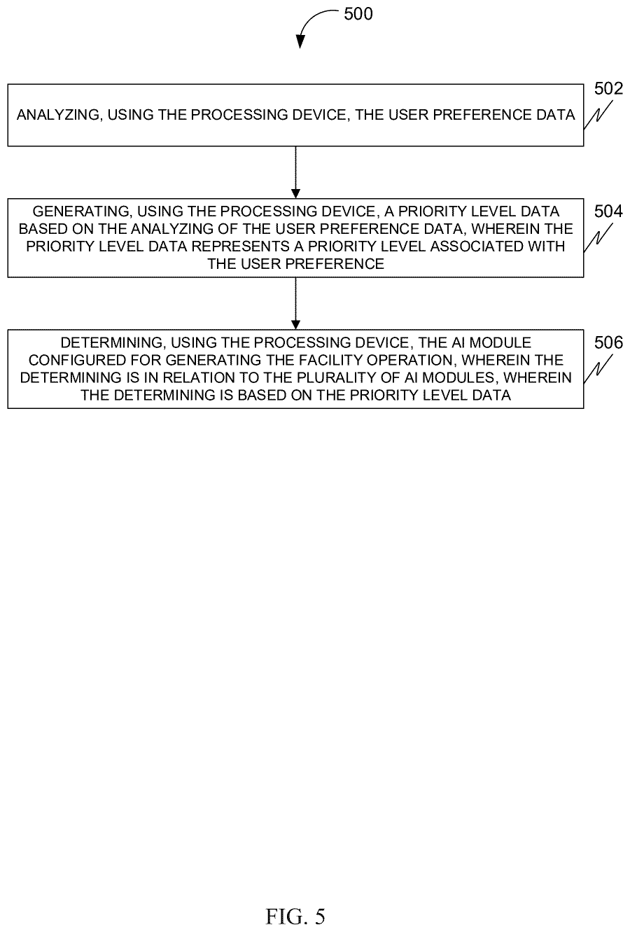

FIG. 5 illustrates a flowchart of a method 500 for facilitating management of a facility operation associated with a facility using digital twins including determining, using the processing device 704, the AI module configured for generating the facility operation, in accordance with some embodiments.

Further, in some embodiments, the AI module may include two or more AI modules. Further, the method 500 further may include a step 502 of analyzing, using the processing device 704, the user preference data. Further, the method 500 further may include a step 504 of generating, using the processing device 704, a priority level data based on the analyzing of the user preference data. Further, the priority level data represents a priority level associated with the user preference. Further, the method 500 further may include a step 506 of determining, using the processing device 704, the AI module which may be configured for generating the facility operation. Further, the determining may be in relation to the two or more AI modules. Further, the determining may be based on the priority level data.

In some embodiments, the priority level data includes one or more of first priority level data, a second priority level data and a third priority level data. Further, the first priority level data corresponds to the user preference associated with a least priority. Further, the second priority level data correspond to the user preference with moderate priority. Further, the third priority level data correspond to user preference with highest priority.

In some embodiments, the method 400 may further include training, using the processing device 704, the AI module based on each of the contextual-factor data and the user feedback data. Further, the training may be further based on a dynamic data-driven adaptation protocol which may be configured for facilitating a dynamic adaption operation in relation to the AI module. Further, the dynamic adaption operation includes one or more of a continuous learning operation and a model updation operation.

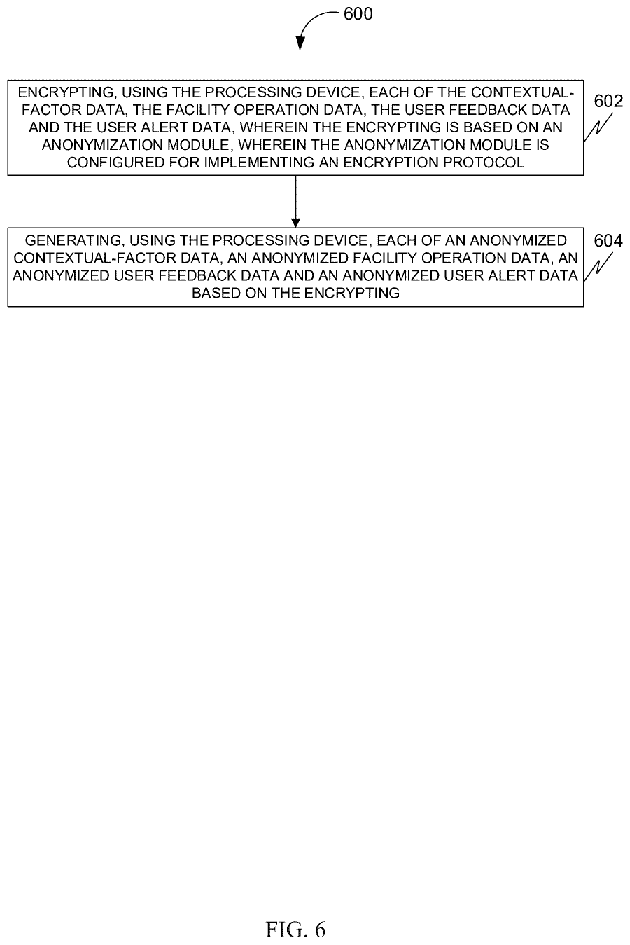

FIG. 6 illustrates a flowchart of a method 600 for facilitating management of a facility operation associated with a facility using digital twins including generating, using the processing device 704, each of an anonymized contextual-factor data, an anonymized facility operation data, an anonymized user feedback data and an anonymized user alert data, in accordance with some embodiments.

Further, in some embodiments, the method 600 further may include a step 602 of encrypting, using the processing device 704, each of the contextual-factor data, the facility operation data, the user feedback data and the user alert data. Further, the encrypting may be based on an anonymization module. Further, the anonymization module may be configured for implementing an encryption protocol. Further, in some embodiments, the method 600 further may include a step 604 of generating, using the processing device 704, each of an anonymized contextual-factor data, an anonymized facility operation data, an anonymized user feedback data and an anonymized user alert data based on the encrypting.

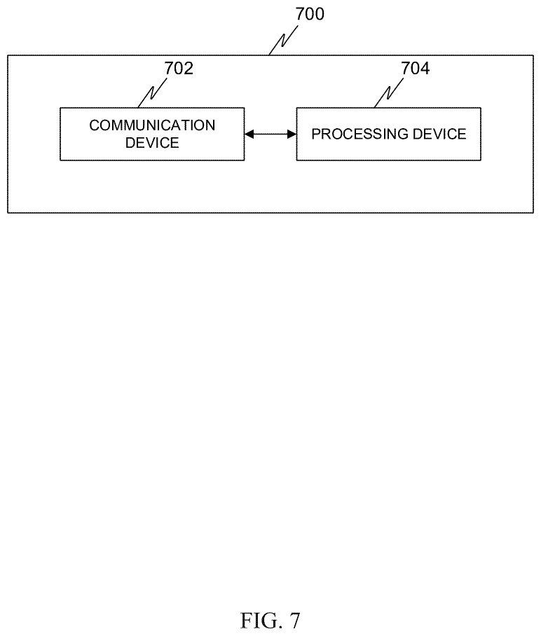

FIG. 7 illustrates a block diagram of a system 700 for facilitating management of a facility operation associated with a facility using digital twins, in accordance with some embodiments.

Accordingly, the system 700 may include a communication device 702. Further, the communication device 702 may be configured for receiving a contextual-factor data from a facility device. Further, the facility device may be comprised in the facility. Further, the contextual-factor data represents one or more of an environment in relation to the facility and a user behavior associated with a user in relation to the facility. Further, the communication device 702 may be configured for transmitting a facility operation data to the facility device. Further, the system 700 may include a processing device 704. Further, the processing device 704 may be configured for analyzing the contextual-factor data. Further, the processing device 704 may be configured for identifying a user preference data based on the analyzing. Further, the user preference data corresponds to a preference of the user in relation to the facility. Further, the processing device 704 may be configured for generating a facility operation data based on the user preference data. Further, the facility operation data corresponds to the facility operation. Further, the facility operation may be in relation to the facility device.

In some embodiments, the processing device 704 may be further configured for generating a facility-digital twin data corresponding to a digital twin of the facility. Further, the generating of the facility operation data may be further based on the facility-digital twin data.

In some embodiments, the analyzing of the contextual-factor data may be based on an AI module.

In some embodiments, the generating of the facility-digital twin may be based on a Digital Twins as a Service architecture which may be configured for facilitating one or more of a creation and a management of the digital twin of a physical asset. Further, the facility may be comprised in the physical asset.

In some embodiments, the processing device 704 may be further configured for generating a user alert data based on the contextual-factor data. Further, the user alert data corresponds to a user alert in relation to each of the environmental condition and the user behavior. Further, the communication device 702 may be further configured for transmitting the user alert data to a user device associated with the user.

In some embodiments, the user alert data may be configured to be presented on a user presentation device associated with the user device. Further, the user device includes a user input device which may be configured for receiving a user feedback data corresponding to a feedback in relation to the user alert. Further, the user device further includes a user communication device which may be configured for transmitting the user feedback data to the communication device 702 further comprising receiving, using the communication device 702, the user feedback data from the user device. Further, the generating of the facility operation data may be further based on the user feedback data.

Further, in some embodiments, the AI module may include two or more AI modules. Further, the processing device 704 may be further configured for analyzing the user preference data. Further, the processing device 704 may be further configured for generating a priority level data based on the analyzing of the user preference data. Further, the priority level data represents a priority level associated with the user preference. Further, the processing device 704 may be further configured for determining the AI module which may be configured for generating the facility operation. Further, the determining may be in relation to the two or more AI modules. Further, the determining may be based on the priority level data.

In some embodiments, the priority level data includes one or more of first priority level data, a second priority level data and a third priority level data. Further, the first priority level data corresponds to the user preference associated with a least priority. Further, the second priority level data correspond to the user preference with moderate priority. Further, the third priority level data correspond to user preference with highest priority.

In some embodiments, the processing device 704 may be further configured for training the AI module based on each of the contextual-factor data and the user feedback data. Further, the training may be further based on a dynamic data-driven adaptation protocol which may be configured for facilitating a dynamic adaption operation in relation to the AI module. Further, the dynamic adaption operation includes one or more of a continuous learning operation and a model updation operation.

Further, in some embodiments, the processing device 704 may be further configured for encrypting each of the contextual-factor data, the facility operation data, the user feedback data and the user alert data. Further, the encrypting may be based on an anonymization module. Further, the anonymization module may be configured for implementing an encryption protocol. Further, the processing device 704 may be further configured for generating each of an anonymized contextual-factor data, an anonymized facility operation data, an anonymized user feedback data and an anonymized user alert data based on the encrypting.

In some embodiments, the facility device includes an IoT device which may be configured for facilitating each of receiving and transmitting of the contextual-factor data associated with the facility.

In some embodiments, the facility operation may be associated with a holistic-quality factor corresponding to a factor in relation to the holistic quality associated with the facility.

In some embodiments, the holistic-quality factor includes one or more of a comfortability factor, efficiency factor and a sustainability factor associated with the facility.

In some embodiments, the user includes an occupant. Further, the facility operation may be configured for facilitating an occupant engagement associated with the occupant in relation to the facility.

In some embodiments, the facility includes a diverse built environment representing a user-made surrounding which may be configured for facilitating a user activity.

In some embodiments, the diverse built environment includes one or more of a residential area, a commercial space, an industrial zone and a public space.

In some embodiments, the user activity includes one or more of a living and a working.

In some embodiments, the contextual-factor data includes a real-time operational data corresponding to a real-time operation in relation to the facility device associated with the facility.

In some embodiments, the user alert data includes one or more of a facility-usage data, a facility usage-history data, a facility-safety data, a facility-health data and a metadata associated with facility.

In some embodiments, the user alert data further includes a resource consumption data corresponding to the alert based on consumption of a resource associated with the facility.

In some embodiments, the resource includes an electric energy.

In some embodiments, the user alert data further includes a sustainability practice data corresponding to a sustainability practice in relation to the resource associated with the facility.

In some embodiments, the user alert data includes an insight data corresponding to an insight in relation to the facility operation.

In some embodiments, the facility device includes two or more facility devices. Further, the two or more facility devices include a facility management device which may be configured for facilitating management of each of the two or more facility devices.

In some embodiments, the facility operation data includes a management command data corresponding to a command associated with the facility management device.

In some embodiments, each of the transmitting and the receiving may be based on a security protocol. Further, the execution of the security protocol may be based on a security standard associated with the facility.

In some embodiments, the user includes a community corresponding to a group of two or more users. Further, the user feedback data includes a community feedback data corresponding to the feedback from the community in relation to the facility. Further, the generating of the facility operation data may be further based on the community feedback data.

In some embodiments, the IoT device includes an industrial IoT device.

In some embodiments, the facility device includes a sensor device which may be configured for detecting an environmental factor associated with the environment in relation to the facility.

In some embodiments, the Digital Twins as a Service architecture may be further configured for prioritizing one or more of a need and an experience of the user in relation to the facility.

In some embodiments, the method 300 may further include generating, using the processing device 704, a refined contextual-factor data. Further, the refined contextual-factor data corresponds to the contextual-factor data refined for any anomalies in relation to facility operation.

In some embodiments, the anomalies include one or more of a structural anomaly corresponding to a structure of the contextual-factor data.

In some embodiments, the generating of the refined contextual-factor data may be further based on a data processing technique. Further, the data processing technique includes an outlier reduction technical which may be configured to utilize an interquartile range associated with the contextual-factor data.

In some embodiments, the data processing technique further includes an imputation technique which may be configured for filling a data gap associated with the contextual-factor data.

In some embodiments, the generating of the refined context-factor data may be further based on a data processing algorithm. Further, the data processing algorithm includes an ensemble kalman filter algorithm which may be configured for facilitating a predictive analysis based on the context-factor data. Further, the generating of the refined context-factor data may be further based on the predictive analysis.

In some embodiments, the method 300 may further include storing, using a storage device, each of the contextual-factor data and the facility operation data associated with the facility.

In some embodiments, the AI module includes a machine learning module.

In some embodiments, the community feedback data includes a maintenance request data corresponding to a maintenance request in relation to the facility operation associated with the facility using digital twins.

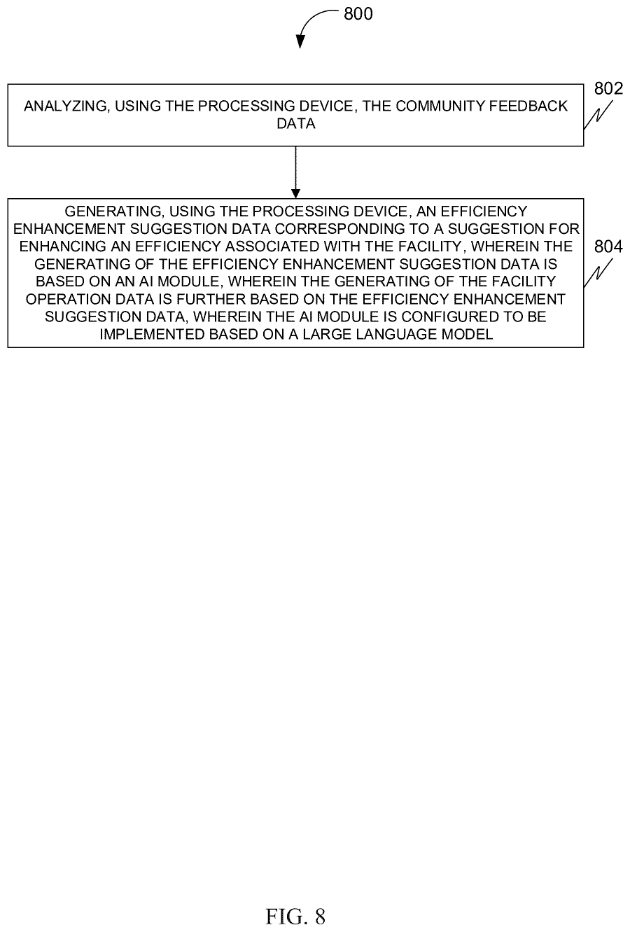

FIG. 8 illustrates a flowchart of a method 800 for facilitating management of a facility operation associated with a facility using digital twins including generating, using the processing device 704, an efficiency enhancement suggestion data corresponding to a suggestion for enhancing an efficiency associated with the facility, in accordance with some embodiments.

Further, in some embodiments, the method 800 further may include a step 802 of analyzing, using the processing device 704, the community feedback data. Further, in some embodiments, the method 800 further may include a step 804 of generating, using the processing device 704, an efficiency enhancement suggestion data corresponding to a suggestion for enhancing an efficiency associated with the facility. Further, the generating of the efficiency enhancement suggestion data may be based on an AI module. Further, the generating of the facility operation data may be further based on the efficiency enhancement suggestion data. Further, the AI module may be configured to be implemented based on a large language model.

In some embodiments, the generating of the refined contextual-factor data may be based on a data integration hub which may be configured for maintaining one or more of a relevance and a usefulness associated with the facility device.

In some embodiments, each of the receiving and the transmitting may be based on a communication protocol. Further, the communication protocol includes one or more of a real-time communication protocol and a request-response communication protocol.

In some embodiments, the real-time communication protocol includes a Web Sockets protocol. Further, the request-response communication protocol includes a RESTful HTTP requests protocol.

In some embodiments, the each of the analyzing, the identifying and the generating may be based on an edge computing module. Further, the edge computing module may be configured for facilitating each of the analyzing, the identifying and the generating in a close-proximity in relation to the facility device.

In some embodiments, the first priority level data may be configured for facilitating an immediate response in relation to the facility operation based on the user preference.

In some embodiments, the two or more AI modules include a lightweight AI module. Further, the facilitating of the immediate response may be based on the lightweight AI module. Further, the lightweight AI module includes one or more of a decision tree AI module and a support vector machine AI module.

In some embodiments, the facility device includes one or more of an occupancy sensor device and a HVAC device. Further, the facility operation includes triggering of an adjustment in relation to the HVAC device based on the occupancy sensor.

In some embodiments, the second priority level data may be configured for facilitating a short-term prediction in relation to the facility operation based on the user preference.

In some embodiments, the two or more AI modules include a recurrent neural network AI module. Further, the facilitating of the short-term prediction may be based on the recurrent neural network AI module. Further, the recurrent neural network AI module includes an LSTM AI module.

In some embodiments, the facility operation includes a forecast in relation to one or more of a short-term user behavior and a short-term environmental change.

In some embodiments, the third priority level data may be configured for facilitating a long-term strategy in relation to the facility operation based on the user preference.

In some embodiments, the two or more AI modules include a reinforcement learning AI module. Further, the facilitating of the long-term strategy may be based on the reinforcement learning AI module.

In some embodiments, the facility operation includes one or more of an energy management and a user comfort in relation to the environment.

In some embodiments, the edge computing module may be further configured for facilitating an immediacy in relation to the facility operation based on the user preference.

In some embodiments, the edge computing module includes an edge node which may be configured for facilitating performance of a pre-processing of the contextual-factor data.

In some embodiments, the edge node may be further configured for reducing one or more of a bandwidth and a latency in relation to a high-frequency data comprised in the contextual-factor data.

In some embodiments, the anonymization module may be further configured for implementing a role-based access control architecture in relation to the facility operation.

In some embodiments, the anonymized user feedback data includes one or more of an interactive poll data, a comfort slider data and a preference toggle-modification data in relation to a software application.

In some embodiments, the sensor device includes a non-intrusive behavioral sensor which may be configured for detecting a non-behavioral characteristic in relation to the user.

In some embodiments, the non-intrusive behavioral sensor includes an ultrasonic sensor which may be configured for detecting the user. Further, the detection may be based on an exclusion of the identification of the user.

In some embodiments, the software application may include a building information modelling software application. Further, the facility may include a building. Further, the facility operation may include a building operation in relation to the building.

Although the invention has been explained in relation to its preferred embodiment, it is to be understood that many other possible modifications and variations can be made without departing from the spirit and scope of the invention as hereinafter claimed.

What is claimed is:

1. A method for facilitating management of a facility operation associated with a facility using digital twins, wherein the method comprising:
receiving, using a communication device, a contextual-factor data from a facility device, wherein the facility device is comprised in the facility, wherein the contextual-factor data represents at least one of an environment in relation to the facility and a user behavior associated with a user in relation to the facility;
analyzing, using a processing device, the contextual-factor data;
identifying, using the processing device, a user preference data based on the analyzing, wherein the user preference data corresponds to a preference of the user in relation to the facility;
generating, using the processing device, a facility operation data based on the user preference data, wherein the facility operation data corresponds to the facility operation, wherein the facility operation is in relation to the facility device; and
transmitting, using the communication device, the facility operation data to the facility device.

2. The method of claim 1 further comprising generating, using the processing device, a facility-digital twin data corresponding to a digital twin of the facility, wherein the generating of the facility operation data is further based on the facility-digital twin data.

3. The method of claim 1, wherein the analyzing of the contextual-factor data is based on an AI module.

4. The method of claim 2, wherein the generating of the facility-digital twin is based on a Digital Twins as a Service architecture configured for facilitating at least one of a creation and a management of the digital twin of a physical asset, wherein the facility is comprised in the physical asset.

5. The method of claim 3 further comprising:
generating, using the processing device, a user alert data based on the contextual-factor data, wherein the user alert data corresponds to a user alert in relation to each of the environmental condition and the user behavior; and
transmitting, using the communication device, the user alert data to a user device associated with the user.

6. The method of claim 5, wherein the user alert data is configured to be presented on a user presentation device associated with the user device, wherein the user device comprises a user input device configured for receiving a user feedback data corresponding to a feedback in relation to the user alert, wherein the user device further comprises a user communication device configured for transmitting the user feedback data to the communication device further comprising receiving, using the communication device, the user feedback data from the user device, wherein the generating of the facility operation data is further based on the user feedback data.

7. The method of claim 3, wherein the AI module comprises a plurality of AI modules, wherein the method further comprising:
analyzing, using the processing device, the user preference data;
generating, using the processing device, a priority level data based on the analyzing of the user preference data, wherein the priority level data represents a priority level associated with the user preference; and
determining, using the processing device, the AI module configured for generating the facility operation, wherein the determining is in relation to the plurality of AI modules, wherein the determining is based on the priority level data.

8. The method of claim 7, wherein the priority level data comprises at least one of first priority level data, a second priority level data and a third priority level data, wherein the first priority level data corresponds to the user preference associated with a least priority, wherein the second priority level data corresponds to the user preference with moderate priority, wherein the third priority level data corresponds to user preference with highest priority.

9. The method of claim 6 further comprising training, using the processing device, the AI module based on each of the contextual-factor data and the user feedback data, wherein the training is further based on a dynamic data-driven adaptation protocol configured for facilitating a dynamic adaption operation in relation to the AI module, wherein the dynamic adaption operation comprises at least one of a continuous learning operation and a model updation operation.

10. The method of claim 6 further comprising:
encrypting, using the processing device, each of the contextual-factor data, the facility operation data, the user feedback data and the user alert data, wherein the encrypting is based on an anonymization module, wherein the anonymization module is configured for implementing an encryption protocol; and
generating, using the processing device, each of an anonymized contextual-factor data, an anonymized facility operation data, an anonymized user feedback data and an anonymized user alert data based on the encrypting.

11. A system for facilitating management of a facility operation associated with a facility using digital twins, wherein the system comprising:
a communication device configured for:
receiving a contextual-factor data from a facility device, wherein the facility device is comprised in the facility, wherein the contextual-factor data represents at least one of an environment in relation to the facility and a user behavior associated with a user in relation to the facility; and
transmitting a facility operation data to the facility device; and
a processing device configured for:
analyzing the contextual-factor data;
identifying a user preference data based on the analyzing, wherein the user preference data corresponds to a preference of the user in relation to the facility; and
generating a facility operation data based on the user preference data, wherein the facility operation data corresponds to the facility operation, wherein the facility operation is in relation to the facility device.

12. The system of claim 11, wherein the processing device is further configured for generating a facility-digital twin data corresponding to a digital twin of the facility, wherein the generating of the facility operation data is further based on the facility-digital twin data.

13. The system of claim 11, wherein the analyzing of the contextual-factor data is based on an AI module.

14. The system of claim 12, wherein the generating of the facility-digital twin is based on a Digital Twins as a Service architecture configured for facilitating at least one of a creation and a management of the digital twin of a physical asset, wherein the facility is comprised in the physical asset.

15. The system of claim 13, wherein the processing device is further configured for generating a user alert data based on the contextual-factor data, wherein the user alert data corresponds to a user alert in relation to each of the environmental condition and the user behavior, wherein the communication device is further configured for transmitting the user alert data to a user device associated with the user.

16. The system of claim 15, wherein the user alert data is configured to be presented on a user presentation device associated with the user device, wherein the user device comprises a user input device configured for receiving a user feedback data corresponding to a feedback in relation to the user alert, wherein the user device further comprises a user communication device configured for transmitting the user feedback data to the communication device further comprising receiving, using the communication device, the user feedback data from the user device, wherein the generating of the facility operation data is further based on the user feedback data.

17. The system of claim 13, wherein the AI module comprises a plurality of AI modules, wherein the processing device is further configured for:
analyzing the user preference data;
generating a priority level data based on the analyzing of the user preference data, wherein the priority level data represents a priority level associated with the user preference; and
determining the AI module configured for generating the facility operation, wherein the determining is in relation to the plurality of AI modules, wherein the determining is based on the priority level data.

18. The system of claim 17, wherein the priority level data comprises at least one of first priority level data, a second priority level data and a third priority level data, wherein the first priority level data corresponds to the user preference associated with a least priority, wherein the second priority level data corresponds to the user preference with moderate priority, wherein the third priority level data corresponds to user preference with highest priority.

19. The system of claim 16, wherein the processing device is further configured for training the AI module based on each of the contextual-factor data and the user feedback data, wherein the training is further based on a dynamic data-driven adaptation protocol configured for facilitating a dynamic adaption operation in relation to the AI module, wherein the dynamic adaption operation comprises at least one of a continuous learning operation and a model updation operation.

20. The system of claim 16, wherein the processing device is further configured for:
encrypting each of the contextual-factor data, the facility operation data, the user feedback data and the user alert data, wherein the encrypting is based on an anonymization module, wherein the anonymization module is configured for implementing an encryption protocol; and
generating each of an anonymized contextual-factor data, an anonymized facility operation data, an anonymized user feedback data and an anonymized user alert data based on the encrypting.
